(19) United States
(12) Patent Application Publication
(10) Pub. No.: US 2026/0188187 A1
(43) Pub. Date: Jul. 2, 2026

(54) Source driver circuits

(71) Applicant: NOVATEK Microelectronics Corp., Hsin-Chu (TW)

(72) Inventor: Yen-Cheng Cheng, Hsinchu City (TW)

(73) Assignee: NOVATEK Microelectronics Corp., Hsin-Chu (TW)

(21) Appl. No.: 19/292,926

(22) Filed: Aug. 7, 2025

(30) Foreign Application Priority Data
Dec. 31, 2024 (TW) 113151611

(51) Int. Cl. G09G 3/32

(52) U.S. Cl. CPC G09G 3/32; G09G 2310/0275; G09G 2310/08; G09G 2330/023; G09G 2330/028

(57) ABSTRACT

A source driver circuit to drive a panel device includes a driving circuit corresponding to a channel. The driving circuit includes multiple pixel circuits coupled to multiple data lines, an operational amplifier and multiple switches. The operational amplifier outputs multiple data voltages in a data-output period to sequentially charge the data lines. The switches are sequentially closed in the data-output period in response to a multiplexing control signal to electrically connect the operational amplifier and a corresponding pixel circuit. The operational amplifier is controlled to operate in a first power mode in the data-output period and operate in a second power mode in a non-data-output period. A slew rate of the first power mode is higher than a slew rate of the second power mode, and the non-data-output period covers a remaining period of a display period of the channel with the data-output period being excluded.

### BACKGROUND OF THE INVENTION

### 1. Field of the Invention

The invention relates to a driver circuit of a panel device, more particular to a driver circuit with reduced power consumption.

### 2. Description of the Prior Art

In recent years, display panels composed of Organic Light-Emitting Diodes (OLED) have become the mainstream in displays. Compared to Liquid Crystal Displays (LCDs), OLED displays can function without a backlight and offer advantages such as high brightness and ease of manufacturing.

Generally, the power consumption of a display system mainly comes from the source driving device which is used to drive the display panel. Therefore, reducing power consumption has always been a critical aspect of product optimization, regardless of whether it is in development of small-sized or large-sized panels.

### SUMMARY OF THE INVENTION

According to an embodiment of the invention, a source driver circuit of a panel device comprises a first pixel circuit coupled to a first data line, a second pixel circuit coupled to a second data line, an operational amplifier outputting a first data voltage in a first data-output period to charge the first data line and outputting a second data voltage in a second data-output period to charge the second data line, a first switch coupled between the operational amplifier and the first pixel circuit and being closed in the first data-output period in response to a first multiplexing control signal to electrically connect the operational amplifier and the first pixel circuit, and a second switch coupled between the operational amplifier and the second pixel circuit and being closed in the second data-output period in response to a second multiplexing control signal to electrically connect the operational amplifier and the second pixel circuit. The operational amplifier is controlled to operate in a first power mode in the first data-output period and the second data-output period, and the operational amplifier is controlled to operate in a second power mode in a non-data-output period. A slew rate of the first power mode is higher than a slew rate of the second power mode.

According to another embodiment of the invention, a source driver circuit to drive a panel device comprises a driving circuit corresponding to a channel. The driving circuit comprises a plurality of pixel circuits coupled to a plurality of data lines, an operational amplifier and a plurality of switches. The operational amplifier outputs a plurality of data voltages in a data-output period to sequentially charge the data lines. The switches are sequentially closed in the data-output period in response to a multiplexing control signal to electrically connect the operational amplifier and a corresponding pixel circuit. The operational amplifier is controlled to operate in a first power mode in the data-output period and operate in a second power mode in a non-data-output period. A slew rate of the first power mode is higher than a slew rate of the second power mode, and the non-data-output period covers a remaining period of a display period of the channel with the data-output period being excluded.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an exemplary circuit diagram of a driving circuit corresponding to one channel of a source driver circuit according to an embodiment of the invention.

FIG. 2 shows a timing diagram of control signals of a pixel circuit according to an embodiment of the invention.

FIG. 3 shows a timing diagram of controlling the power mode of the operational amplifier according to an embodiment of the invention.

FIG. 4 shows an exemplary circuit diagram of an operational amplifier according to an embodiment of the invention.

FIG. 5 shows an exemplary block diagram of a panel device according to an embodiment of the invention.

FIG. 6 shows a timing diagram of power mode switching controlled by timers according to an embodiment of the invention.

### DETAILED DESCRIPTION

As described above, the power consumption of a display system mainly comes from the source driving device which is used to drive the display panel. In the disclosure, a novel design of a source driver circuit is proposed, where the power consumption of the source driver circuit is effectively reduced without affecting the display performance.

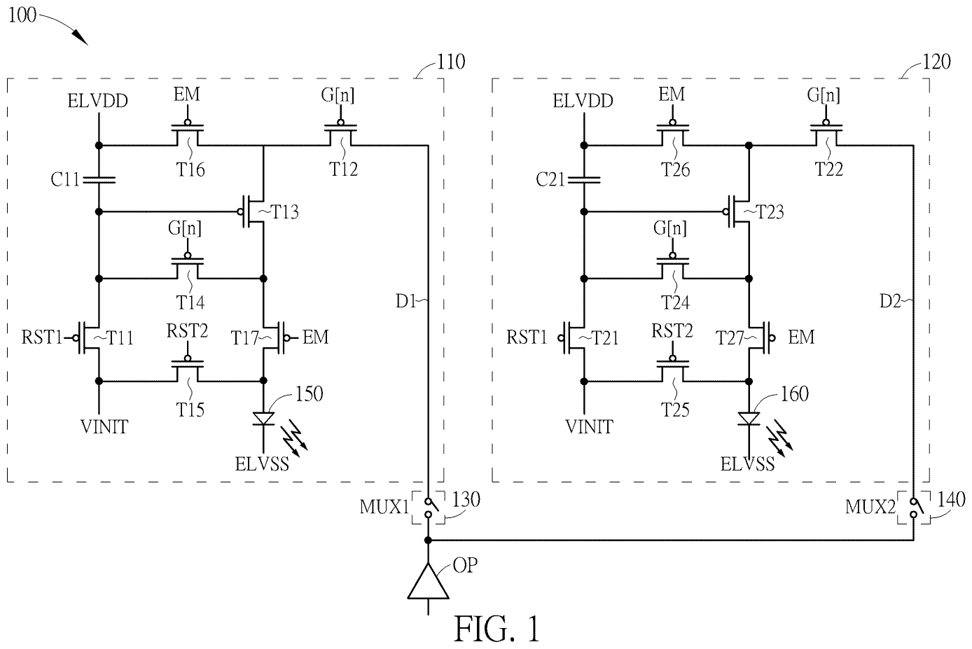

FIG. 1 shows an exemplary circuit diagram of a driving circuit corresponding to one channel of a source driver circuit according to an embodiment of the invention. In the embodiments, the source driver circuit comprises a plurality of channels and each channel is equipped with an operational amplifier to provide data voltages for driving the display operation of the panel device.

According to an embodiment of the invention, to reduce the number of operational amplifiers in the source driver circuit, the driving circuit corresponding to one channel comprises a plurality of pixel circuits and the operational amplifier is shared by the pixel circuit, to sequential provide the data voltages to the pixel circuits. For example, for one line (a horizontal line) of the panel device, one operational amplifier may be configured to trigger a plurality of data lines, where each pixel circuit is coupled to one data line. By controlling the on-off status (for example, being closed or opened) of the corresponding switches, the operational amplifier sequentially provides the data voltages to the corresponding data lines of the pixel circuits in a time division multiplexing manner.

Note that in the disclosure, one pixel may be one pixel unit of the panel device, and in the implementations where one pixel unit is formed by multiple sub-pixels (for example, one pixel unit is formed by red (R), green (G), and blue (B) sub-pixels), the pixels and pixel circuits mentioned in this disclosure may be respectively referred to the sub-pixels and sub-pixel circuits.

In addition, note that in the embodiments of the invention, one line (a horizontal line) of the panel device refers to a line extending along the row direction or the horizontal direction. On the contrary, the data lines of the panel device are extending along the column direction or the vertical direction. For a Full High Definition (Full HD) 1920*1080 high resolution panel device, there are 1920 pixel units in the horizontal direction, and each pixel unit is formed by three sub-pixels. Therefore, there are 1920*3 sub-pixels in horizontal direction and 1080 sub-pixels in vertical direction. A row of sub-pixels distributed along the row direction or horizontal direction is defined as one line of the panel device. Therefore, a Full HD panel device comprises 1080 lines when counted along the vertical direction.

According to an embodiment of the invention, the driving circuit 100 comprises an operational amplifier OP, pixel circuits 110 and 120, and switches 130 and 140 coupled between the operational amplifier OP and the pixel circuits, wherein the pixel circuits 110 and 120 are respectively coupled to data lines D1 and D2. FIG. 1 shows a 7T1C pixel circuit, that is, a pixel circuit comprises 7 thin-film transistors (TFT) and 1 capacitor.

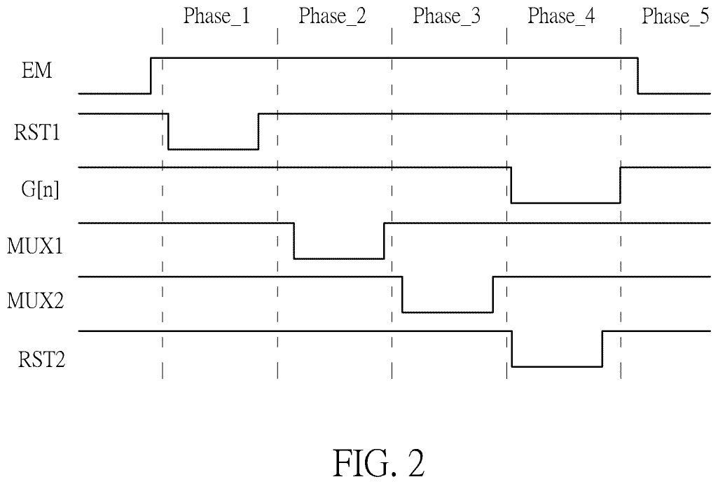

FIG. 2 shows a timing diagram of control signals of a pixel circuit according to an embodiment of the invention. According to an embodiment of the invention, the display period corresponding to one channel may be divided into multiple phases, for example, phases Phase_1˜Phase_5 as shown in FIG. 2. By sequentially turning on different transistors via the control signals, operations such as initial voltage setting, data line charging, and voltage storing, . . . etc., are sequentially completed in each phase, allowing the two pixel circuits driven by this channel to emit light in the last phase of the display period according to the system voltages ELVDD and ELVSS and the data voltage output by the operational amplifier OP.

More specifically, referring to FIG. 1 and FIG. 2 together, in the first phase Phase_1, the voltage of the control signal RST1 is pulled low, the transistors T11 and T21 are turned on, and the capacitors C11 and C21 are charged according to the initial voltage VINIT, thereby resetting the voltages at the nodes of the capacitors C11 and C21 to a fixed voltage before each light emission. In the second phase Phase_2, the voltage of the control signal MUX1 is pulled low, the switch 130 is closed, and the operational amplifier OP is electrically connected to the pixel circuit 110. The operational amplifier OP outputs the corresponding data voltage to charge the data line D1.

In the third phase Phase_3, the voltage of the control signal MUX2 is pulled low, the switch 140 is closed, and the operational amplifier OP is electrically connected to the pixel circuit 120. The operational amplifier OP outputs the corresponding data voltage to charge the data line D2. In the fourth phase Phase_4, the voltage of the control signal G[n] is pulled low, the transistors T12, T14, T22, and T24 are turned on, and the transistors T13 and T23 are also turned on. The voltages on data lines D1 and D2 are respectively stored in the capacitors C11 and C21. The voltages stored in the capacitor C11 (or the capacitor C21) are (Data-Vth), where the ‘Data’ is the voltage stored on the data line D1 (or the data line D2), and the ‘Vth’ is the threshold voltage of the transistor T13 (or the transistor T23). Additionally, the voltage of the control signal RST2 is also pulled low in the fourth phase Phase_4, the transistors T15 and T25 are turned on to charge the nodes of the light-emitting diodes (LEDs) 150 and 160. In the fifth phase Phase_5, the voltage of the control signal EM is pulled low, the transistors T16, T17, T26, and T27 are turned on, the LEDs 150 and 160 begin to emit light, and the emission time will continue for a frame time.

As described above, the operational amplifier OP continues to operate during the display period of the corresponding channel. However, as shown in the timing diagram of FIG. 2, the operational amplifier OP outputs the corresponding data voltages to charge data lines D1 and D2 when the switches 130 and 140 are closed (e.g., in the second phase Phase_2 and the third phase Phase_3). In other phases, under the control of the control signals MUX1 and MUX2, the switches 130 and 140 will be opened to disconnect the electrical connection between the operational amplifier OP and the pixel circuits, but the operational amplifier OP is still in an enabled state. Therefore, the operational amplifier OP will still consume power even in the phases where the operation of the operational amplifier OP is not required. In other words, the operation of the operational amplifier OP will produce additional power consumption when the switches 130 and 140 are opened. Especially, since the light emission of the LEDs will continue for a frame time, a large amount of power consumption will be generated by the operational amplifier OP during the light-emitting phase of the LEDs.

To reduce additional power consumption, in the embodiments of the invention, the operational amplifier OP is controlled to switch between different power modes. For example, during the data-output period (e.g., a period including the aforementioned second phase Phase_2 and the third phase Phase_3) for outputting data voltages to charge the data lines, the operational amplifier OP is controlled to operate in a first power mode, and during a non-data-output period (e.g., the remaining period after excluding the second phase Phase_2 and the third phase Phase_3 from the display period), the operational amplifier OP is controlled to operate in a second power mode, wherein the slew rate of the first power mode is higher than the slew rate of the second power mode. Or, for a bias current in the operational amplifier OP circuit, the magnitude of the bias current when the operational amplifier OP operates in the first power mode is greater than that when the operational amplifier OP operates in the second power mode.

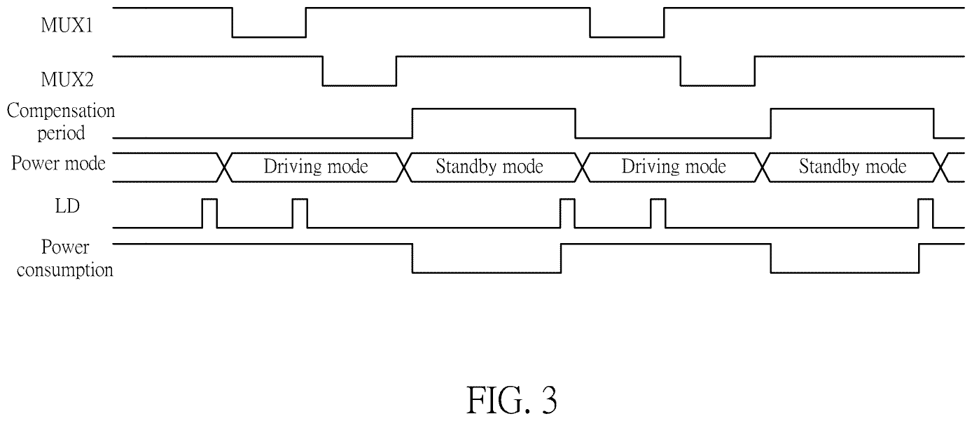

FIG. 3 shows a timing diagram of controlling the power mode of the operational amplifier according to an embodiment of the invention. In this example, the power mode of the operational amplifier OP is switched between a driving mode (or, the first power mode) and a standby mode (or, the second power mode) in response to the control signals of the panel device, wherein the slew rate of the driving mode is higher than the slew rate of the standby mode. Additionally, in this example, the period when the voltages of control signals MUX1 and MUX2 are pulled low is the data-output period of the operational amplifier OP, and the remaining period other than the data-output period is collectively referred to as the non-data-output period or compensation period (as shown in FIG. 3, the compensation period of the corresponding channel is indicated by the high level of the compensation period indicator depicted below the control signals MUX1 and MUX2).

According to an embodiment of the invention, the non-data-output period or compensation period may cover the remaining period of the display period corresponding to the channel after excluding the data-output period of the operational amplifier OP. Taking the examples shown in FIG. 1 and FIG. 2 for more specific explanation, the data-output period of the operational amplifier OP comprises a first data-output period (e.g., the period of the second phase Phase_2) during which the operational amplifier OP charges data line D1 and a second data-output period (e.g., the period of the third phase Phase_3) during which the operational amplifier OP charges data line D2, while the non-data-output period or the compensation period comprises the periods of the first phase Phase_1, the fourth phase Phase_4, and the fifth phase Phase_5.

In the example shown in FIG. 3, LD is a data update signal. The pulse of the data update signal LD (i.e., when the voltage is pulled high) is used to indicate that the data on the data lines need to be updated. According to an embodiment of the invention, in response to the sequential arrival of pulses of the data update signal LD, the voltages of control signals MUX1 and MUX2 are sequentially pulled low. At this time, the data-output period of the operational amplifier OP is entered, and the operational amplifier OP is controlled to operate in the driving mode. After the data-output period of the operational amplifier OP ends, the compensation period is entered and the operational amplifier OP is controlled to operate in the standby mode.

FIG. 3 also shows the power consumption of the operational amplifier OP. In the embodiments of the invention, in the standby mode, the operational amplifier OP has lower power consumption, thereby effectively reducing the power consumption of the source driver circuit without affecting the display performance.

Note that although FIG. 1 shows a 7T1C pixel circuit, the invention is not limited to applications with 7T1C pixel circuits. Those skilled in the art will understand that other structures of pixel circuits, such as 8T1C pixel circuits, also operate in a similar manner. Therefore, the proposed novel source driver circuit design is certainly applicable to the pixel circuit structures with different numbers of transistors and capacitors.

In addition, note that although FIG. 1 shows a structure where two pixel circuits share one operational amplifier in one channel, and FIG. 2 and FIG. 3 show the control signal timing diagrams based on this structure, the invention is not limited to only the applications where two pixel circuits share one operational amplifier. In the embodiments of the invention, the driving circuit corresponding to one of the plurality of channels of the source driver circuit may comprise a plurality of pixel circuits coupled to a plurality of data lines, a plurality of switches, and one operational amplifier. Each pixel circuit is coupled to one data line, and the operational amplifier outputs a plurality of data voltages during a data-output period to sequentially charge the data lines. Each switch corresponds to one pixel circuit, and each switch is closed in response to a corresponding multiplexing control signal during the data-output period to electrically connect the operational amplifier and the corresponding pixel circuit. In the embodiments of the invention, during the data-output period, the operational amplifier is controlled to operate in a power mode with a higher slew rate, and during the non-data-output period, the operational amplifier is controlled to operate in another power mode with a lower slew rate or lower power consumption. Therefore, the pixel circuit shown in FIG. 1 is only one exemplary application of the invention and is not intended to limit the scope of the invention. The proposed source driver circuit design is certainly applicable to the driving circuit structures with different numbers of pixel circuits and switches.

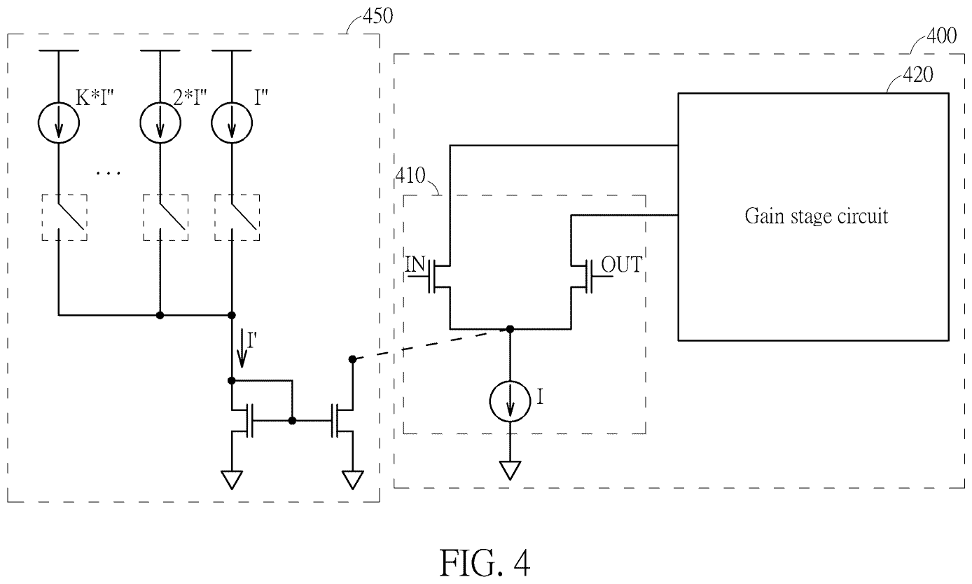

FIG. 4 shows an exemplary circuit diagram of an operational amplifier according to an embodiment of the invention. According to an embodiment of the invention, the operational amplifier 400 comprises an input stage circuit 410 and a gain stage circuit 420. The input stage circuit 410 comprises an input terminal IN and an output terminal OUT, as well as a bias current I. The gain stage circuit 420 is coupled to the input stage circuit 410. According to an embodiment of the invention, by controlling the magnitude of the bias current I, the operational amplifier 400 is controlled to operate in different power modes.

More specifically, according to an embodiment of the invention, the magnitude of the bias current I may be controlled through a current mirror circuit 450. The current mirror circuit 450 may generate a reference current I′ through current weighting, and the bias current I may be mapped from the reference current I′. The current mirror circuit 450 may comprise a plurality of switches and a plurality of bias currents, such as the bias currents I″, 2*I″, . . . , K*I″ shown in FIG. 4. By controlling the on-off status or the conduction state of the switches, the current mirror circuit 450 generates the required reference current I′ through current weighting based on the bias currents I″, 2*I″, . . . , K*I″.

Note that using a current mirror circuit to control the bias current of the operational amplifier is only one implementation of the invention and is not a limitation of the invention. Those skilled in the art will understand that the invention may also use other circuits or methods to control the magnitude of the current in the operational amplifier.

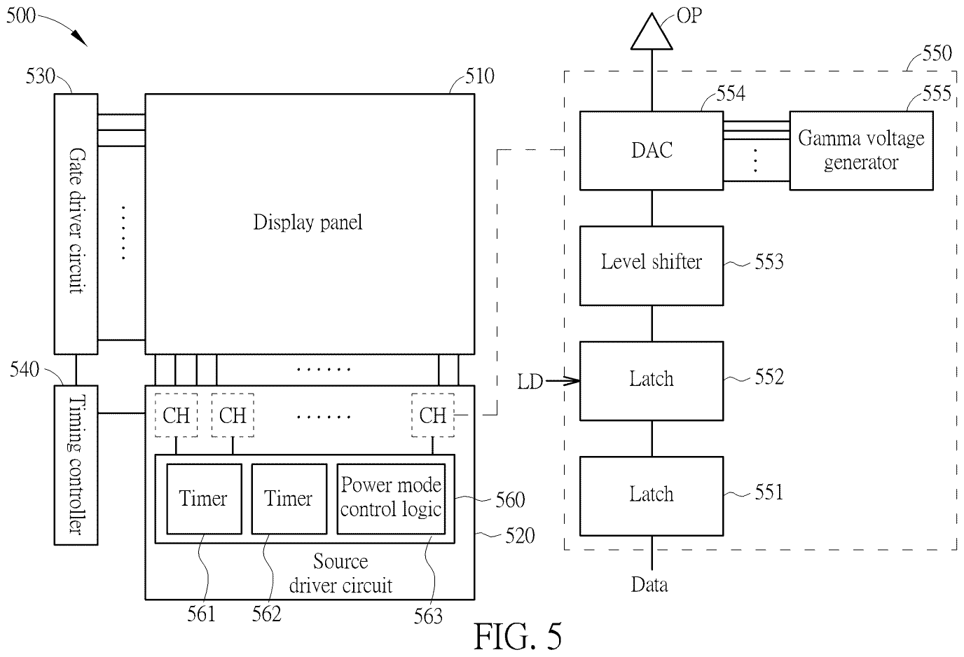

FIG. 5 shows an exemplary block diagram of a panel device according to an embodiment of the invention. The panel device 500 may comprise a display panel 510, a source driver circuit 520, a gate driver circuit 530, and a timing controller 540. The display panel 510 may comprise a pixel array, where the pixel array may comprise a plurality of pixel units arranged in a plurality of columns and rows. The source driver circuit 520 may comprise a plurality of channels CH and is coupled to the display panel 510 through a plurality of data lines. The gate driver circuit 530 is coupled to the display panel 510 through a plurality of gate lines. The timing controller 540 is coupled to the source driver circuit 520 and the gate driver circuit 530, and outputs a plurality of timing control signals to control the operation of the source driver circuit 520 and the gate driver circuit 530.

According to an embodiment of the invention, each channel CH may have a corresponding driving circuit (e.g., the driving circuit 100 shown in FIG. 1) and a data voltage generating circuit (e.g., the data voltage generating circuit 550 shown in FIG. 5). The data voltage generating circuit 550 may be coupled to the operational amplifier OP in the driving circuit, and provide data voltages to the operational amplifier OP in response to a data update signal (e.g., the data update signal LD). According to an embodiment of the invention, the data voltage generating circuit 550 may sequentially provide data voltages corresponding to a plurality of data lines to the operational amplifier OP in response to a plurality of pulses of the data update signal LD.

According to an embodiment of the invention. the data voltage generating circuit 550 may comprise latches 551 and 552, a level shifter 553, a Digital to Analog Converter (DAC) 554, and a gamma voltage generator 555. Taking the driving circuit structure in which a single operational amplifier drives two data lines as an example, the latches 551 and 552 are used to temporarily store the data Data that needs to be provided to the two data lines. As shown in FIG. 3, two pulses will be sequentially generated in the data update signal LD. In response to the first pulse, the data Data for the first data line (e.g., data line D1) is stored in the latch 551. In response to the second pulse, the data stored in the latch 551 is pushed into the latch 552, and the data Data for the second data line (e.g., data line D2) is stored in the latch 551.

The level shifter 553 adjusts the voltage level of the data, for example, converting the data Data from a low voltage signal to a high voltage signal. The DAC 554 selects the corresponding gamma voltage from the gamma voltage generator 555 based on the output voltage of the level shifter 553, and provides the gamma voltage as the data voltage to the operational amplifier OP. Therefore, in the embodiments of the invention, the data voltage generating circuit 550 may provide a first data voltage to the operational amplifier OP in response to the first pulse of the data update signal LD (which may also be regarded as a first data update signal), and provide a second data voltage to the operational amplifier OP in response to the second pulse of the data update signal LD (which may also be regarded as a second data update signal). The operational amplifier OP sequentially outputs the first data voltage and the second data voltage to charge the data lines. At the time when the operational amplifier OP outputs a data voltage, the data Data for the next line (horizontal line) is stored in latch 551.

According to an embodiment of the invention, the source driver circuit 520 comprises a control circuit 560. The control circuit 560 may be coupled to the operational amplifier OP in the driving circuit or coupled to a current mirror circuit that controls the magnitude of the current in the operational amplifier OP. In the embodiments of the invention, the control circuit 560 controls the operational amplifier OP to operate in the first power mode or the second power mode in response to the data update signal (e.g., the data update signal LD). For example, the control circuit 560 may control the operational amplifier OP to operate in the first power mode or the second power mode in response to one of the plurality of pulses of the data update signal LD.

According to an embodiment of the invention, the control circuit 560 comprises timers 561 and 562, and a power mode control logic 563. The timer 561 may count a first time in response to the data update signal LD, and the timer 562 may count a second time in response to the data update signal LD, where the second time is longer than the first time. The power mode control logic 563 controls the operational amplifier OP to switch from the first power mode with a higher slew rate to the second power mode with a lower slew rate in response to an expiration of the timer 561, for example, when the operational amplifier OP is operating in the first power mode, and controls the operational amplifier OP to switch back to the first power mode from the second power mode in response to an expiration of the timer 562 when the operational amplifier OP is operating in the second power mode. According to an embodiment of the invention, the power mode control logic 563 may control the operational amplifier OP to switch to the first power mode or the second power mode by controlling the magnitude of the bias current I of the operational amplifier OP as described above.

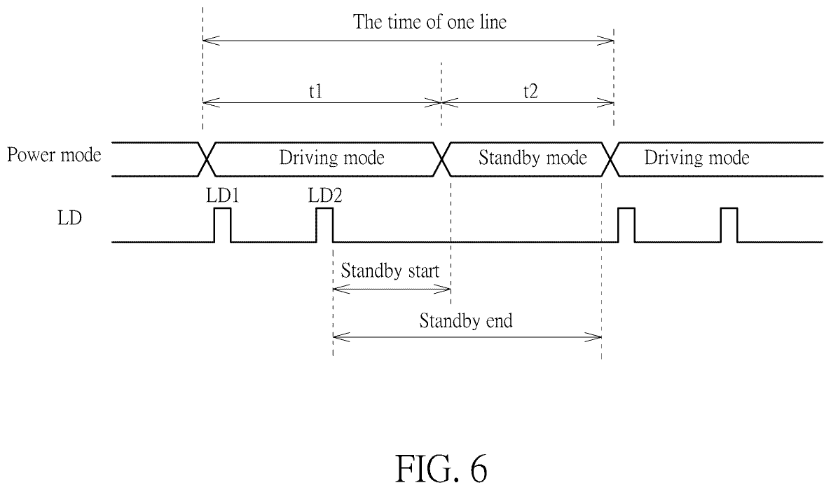

FIG. 6 shows a timing diagram of power mode switching controlled by timers according to an embodiment of the invention. Assuming that the time of one line (horizontal line) (e.g., the display period of one line) is divided into two periods t1 and t2, where t1 is the data-output period and t2 is the non-data-output period, the control circuit 560 controls the operational amplifier OP to operate in the driving mode with a higher slew rate during the data-output period t1, and controls the operational amplifier OP to operate in the standby mode with a lower slew rate during the non-data-output period t2.

According to an embodiment of the invention, the data update signal LD comprises two pulses LD1 and LD2 within the time of one line. The timer 561 counts the first time in response to the second pulse LD2 (or, the last pulse) of the data update signal LD, and the timer 562 counts the second time in response to the second pulse LD2 of the data update signal LD, where the second time is longer than the first time. When the timer 561 expires, the power mode control logic 563 controls the operational amplifier OP to switch from the driving mode with a higher slew rate to the standby mode with a lower slew rate (as shown by the “Standby start” in FIG. 6). When the timer 562 expires, the power mode control logic 563 controls the operational amplifier OP to switch back to the driving mode from the standby mode (as shown by the “Standby end” in FIG. 6).

According to an embodiment of the invention, the control circuit 560 or the source driver circuit 520 may comprise a register (not shown in the figures). The information regarding the lengths of the time counted by the timer 561 and the timer 562 can be written into the register through frame commands, achieving the result of dynamically adjusting the power mode of the operational amplifier OP within the time of one line (horizontal line).

In addition, in the embodiments of the invention, besides controlling the power mode of the operational amplifier OP, the dynamically adjusting of the power mode within the time of one line is also applicable to other analog circuits, for example, applying to the analog circuits related to the operation of the operational amplifier OP. By dynamically adjusting the power mode or operation mode of the operational amplifier OP and related analog circuits within the time of one line, the operational amplifier OP and related analog circuits can operate in a mode with lower power consumption during the non-data-output period of the operational amplifier OP, and the overall power consumption of the source driver circuit is effectively reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A source driver circuit of a panel device, comprising:
a first pixel circuit, coupled to a first data line;
a second pixel circuit, coupled to a second data line;
an operational amplifier, outputting a first data voltage in a first data-output period to charge the first data line, and outputting a second data voltage in a second data-output period to charge the second data line;
a first switch, coupled between the operational amplifier and the first pixel circuit and being closed in the first data-output period in response to a first multiplexing control signal to electrically connect the operational amplifier and the first pixel circuit; and
a second switch, coupled between the operational amplifier and the second pixel circuit and being closed in the second data-output period in response to a second multiplexing control signal to electrically connect the operational amplifier and the second pixel circuit,
wherein the operational amplifier is controlled to operate in a first power mode in the first data-output period and the second data-output period, and the operational amplifier is controlled to operate in a second power mode in a non-data-output period, and
wherein a slew rate of the first power mode is higher than a slew rate of the second power mode.

2. The source driver circuit of claim 1, further comprising a plurality of channels, wherein the first pixel circuit, the second pixel circuit, the operational amplifier, the first switch and the second switch are comprised in a driver circuit corresponding to one of the channels, and the non-data-output period covers a remaining period of a display period of the one of the channels with the first data-output period and the second data-output period being excluded.

3. The source driver circuit of claim 1, wherein the operational amplifier comprises:
an input stage circuit, comprising a bias current; and
a gain stage circuit, coupled to the input stage circuit,
wherein the operational amplifier is controlled to operate in the first power mode or the second power mode by controlling a magnitude of the bias current.

4. The source driver circuit of claim 1, further comprising:
a data voltage generating circuit, coupled to the operational amplifier, providing the first data voltage to the operational amplifier in response to a data update signal and providing the second data voltage to the operational amplifier in response to the data update signal.

5. The source driver circuit of claim 4, further comprising:
a control circuit, coupled to the operational amplifier, wherein the control circuit controls the operational amplifier to operate in the first power mode or the second power mode in response to the data update signal.

6. The source driver circuit of claim 5, wherein the control circuit further comprises:
a first timer, counting a first time in response to the data update signal;
a second timer, counting a second time in response to the data update signal, wherein the second time is longer than the first time; and
a power mode control logic, controlling the operational amplifier to switch from the first power mode to the second power mode in response to an expiration of the first timer when the operational amplifier is operating in the first power mode, and controlling the operational amplifier to switch from the second power mode to the first power mode in response to an expiration of the second timer when the operational amplifier is operating in the second power mode.

7. The source driver circuit of claim 6, wherein the power mode control logic controls the operational amplifier to switch to the first power mode or the second power mode by controlling a magnitude of a bias current of the operational amplifier.

8. A source driver circuit of a panel device, comprising:
a driving circuit, corresponding to a channel and comprising:
a plurality of pixel circuits, coupled to a plurality of data lines, wherein each pixel circuit is coupled to one of the data lines;
an operational amplifier, outputting a plurality of data voltages in a data-output period to sequentially charge the data lines; and
a plurality of switches, coupled between the operational amplifier and the pixel circuits, wherein each switch is corresponding to one of the pixel circuits and is closed in the data-output period in response to a multiplexing control signal to electrically connect the operational amplifier and the corresponding pixel circuit,
wherein the operational amplifier is controlled to operate in a first power mode in the data-output period and operate in a second power mode in a non-data-output period,
wherein a slew rate of the first power mode is higher than a slew rate of the second power mode, and
wherein the non-data-output period covers a remaining period of a display period of the channel with the data-output period being excluded.

9. The source driver circuit of claim 8, wherein the operational amplifier comprises:
an input stage circuit, comprising a bias current; and
a gain stage circuit, coupled to the input stage circuit,
wherein the operational amplifier is controlled to operate in the first power mode or the second power mode by controlling a magnitude of the bias current.

10. The source driver circuit of claim 8, further comprising:
a data voltage generating circuit, coupled to the driving circuit, and providing the data voltages to the operational amplifier in response to a data update signal.

11. The source driver circuit of claim 10, further comprising:
a control circuit, coupled to the operational amplifier, wherein the control circuit controls the operational amplifier to operate in the first power mode or the second power mode in response to the data update signal.

12. The source driver circuit of claim 11, wherein the control circuit further comprises:
a first timer, counting a first time in response to the data update signal;
a second timer, counting a second time in response to the data update signal, wherein the second time is longer than the first time; and
a power mode control logic, controlling the operational amplifier to switch from the first power mode to the second power mode in response to an expiration of the first timer when the operational amplifier is operating in the first power mode, and controlling the operational amplifier to switch from the second power mode to the first power mode in response to an expiration of the second timer when the operational amplifier is operating in the second power mode.

13. The source driver circuit of claim 12, wherein the power mode control logic controls the operational amplifier to switch to the first power mode or the second power mode by controlling a magnitude of a bias current of the operational amplifier.
